(19) United States
(12) Patent Application Publication
(10) Pub. No.: US 2015/0356199 A1
(43) Pub. Date: Dec. 10, 2015

(54) CLICK-THROUGH-BASED CROSS-VIEW LEARNING FOR INTERNET SEARCHES

(71) Applicant: Microsoft Corporation, Redmond, WA (US)

(72) Inventors: Tao MEI, Beijing (CN); Yong RUI, Sammamish, WA (US); Linjun YANG, Sammamish, WA (US); Ting YAO, Beijing (CN)

(73) Assignee: MICROSOFT CORPORATION, Redmond, WA (US)

(21) Appl. No.: 14/323,994

(22) Filed: Jul. 3, 2014

Related U.S. Application Data
(60) Provisional application No. 62/009,080, filed on Jun. 6, 2014.

(51) Int. Cl. G06F 17/30

(52) U.S. Cl. CPC G06F 17/30917; G06F 17/30864; G06F 17/3053

(57) ABSTRACT

The description relates to click-through-based cross-view learning for internet searches. One implementation includes determining distances among textual queries and/or visual images in a click-through-based structured latent subspace. Given new content, results can be sorted based on the distances in the click-through-based structured latent subspace.

### BACKGROUND

One of the fundamental problems in internet image searches is to rank visual images according to a given textual query. Existing search engines can depend on text descriptions associated with visual images for ranking the images, or leverage query-image pairs annotated by human labelers to train a series of ranking functions. However, there are at least two major limitations to these approaches: 1) text descriptions associated with visual images are often noisy or too few to accurately or sufficiently describe salient aspects of image content, and 2) human labeling can be resourcefully expensive and can produce incomplete and/or erroneous labels. The present implementations can mitigate the above two fundamental challenges, among others.

### SUMMARY

The description relates to click-through-based cross-view learning for internet searches. One implementation includes receiving textual queries from a textual query space that has a first structure, visual images from a visual image space that has a second structure, and click-through data related to the textual queries and the visual images. Mapping functions can be learned that map the textual queries and the visual images into a click-through-based structured latent subspace based on the first structure, the second structure, and the click-through data. Another implementation includes determining distances among the textual queries and/or the visual images in the click-through-based structured latent subspace. Given new content, results can be sorted based on the distances in the click-through-based structured latent subspace.

The above listed example is intended to provide a quick reference to aid the reader and is not intended to define the scope of the concepts described herein.

### BRIEF DESCRIPTION OF THE DRAWINGS

The accompanying drawings illustrate implementations of the concepts conveyed in the present document. Features of the illustrated implementations can be more readily understood by reference to the following description taken in conjunction with the accompanying drawings. Like reference numbers in the various drawings are used wherever feasible to indicate like elements. In some cases parentheticals are utilized after a reference number to distinguish like elements. Use of the reference number without the associated parenthetical is generic to the element. Further, the left-most numeral of each reference number conveys the FIG. and associated discussion where the reference number is first introduced.

FIGS. 1-2 collectively illustrate an exemplary click-through-based cross-view learning scenario that is consistent with some implementations of the present concepts.

FIGS. 3-6 illustrate an example click-through-based cross-view learning use-case scenario that is consistent with some implementations of the present concepts.

FIGS. 7-8 illustrate an example click-through-based cross-view learning system that is consistent with some implementations of the present concepts.

FIGS. 9 and 10 are flowcharts of example click-through-based cross-view learning techniques in accordance with some implementations of the present concepts.

### DETAILED DESCRIPTION

### Overview

This description relates to improving results for internet searches and more specifically to click-through-based cross-view learning (CCL). In some implementations, click-through-based cross-view learning can include projecting textual queries and visual images into a latent subspace (e.g., a low-dimensional feature representation space). Click-through-based cross-view learning can make the different modalities (e.g., views) of the textual queries and the visual images comparable in the latent subspace (e.g., shared latent subspace, common latent subspace). For example, the textual queries and visual images can be compared by mapping distances in the latent subspace. In some cases, the distances can be mapped based on click-through data and structures from an original textual query space and an original visual image space. As such, click-through-based cross-view learning can 1) reduce (and potentially minimize) the distance between mappings of textual queries and visual images in the latent subspace, and 2) preserve inherent structure from the original textual query and visual image spaces in the latent subspace. In these cases, the latent subspace can be considered a click-through-based structured latent subspace.

The latent subspace mapped using click-through-based cross-view learning techniques can be used to improve visual image search results with textual queries. For example, relevance scores (e.g., similarities) between the textual queries and the visual images can be determined based on the distances in the mapped latent subspace. In some cases, the relevance scores can provide improved search results for visual images from textual queries, and a visual image search list can be returned for a textual query by sorting the relevance scores. In some cases, click-through-based cross-view learning techniques can achieve improvements over other methods (e.g., other subspace learning techniques) in terms of relevance of textual query to visual image results. Additionally, click-through-based cross-view learning techniques can reduce feature dimension by several orders of magnitude (e.g., from thousands to tens) compared with that of the original textual query and/or visual image spaces, producing memory savings compared to existing search systems.

To summarize, textual queries and visual images can be projected into a latent subspace using click-through-based cross-view learning techniques. The textual queries and visual images within the latent subspace can be mapped. Distances between relevant textual queries and visual images can be reduced, and structure from original textual query and visual image spaces can be preserved. The mapped latent subspace can be used to determine relevance scores for visual images corresponding to textual queries, and an image search list can be returned for a textual query by sorting the relevance scores.

### First Scenario Example

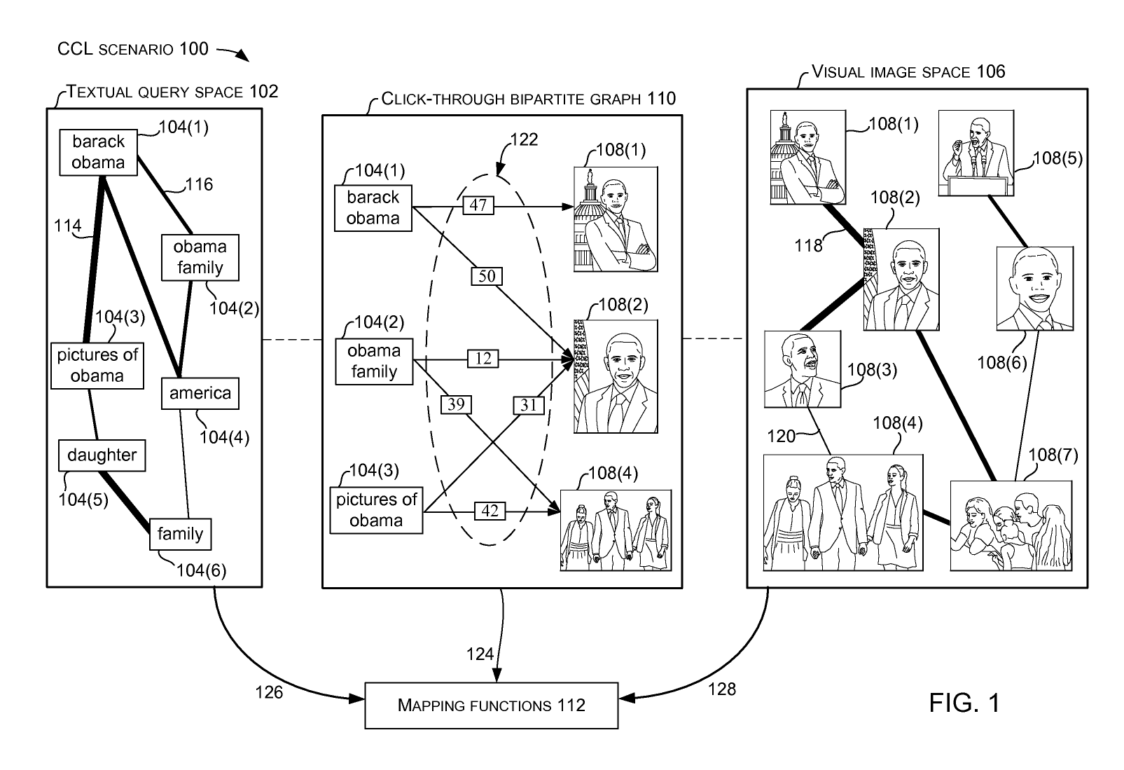

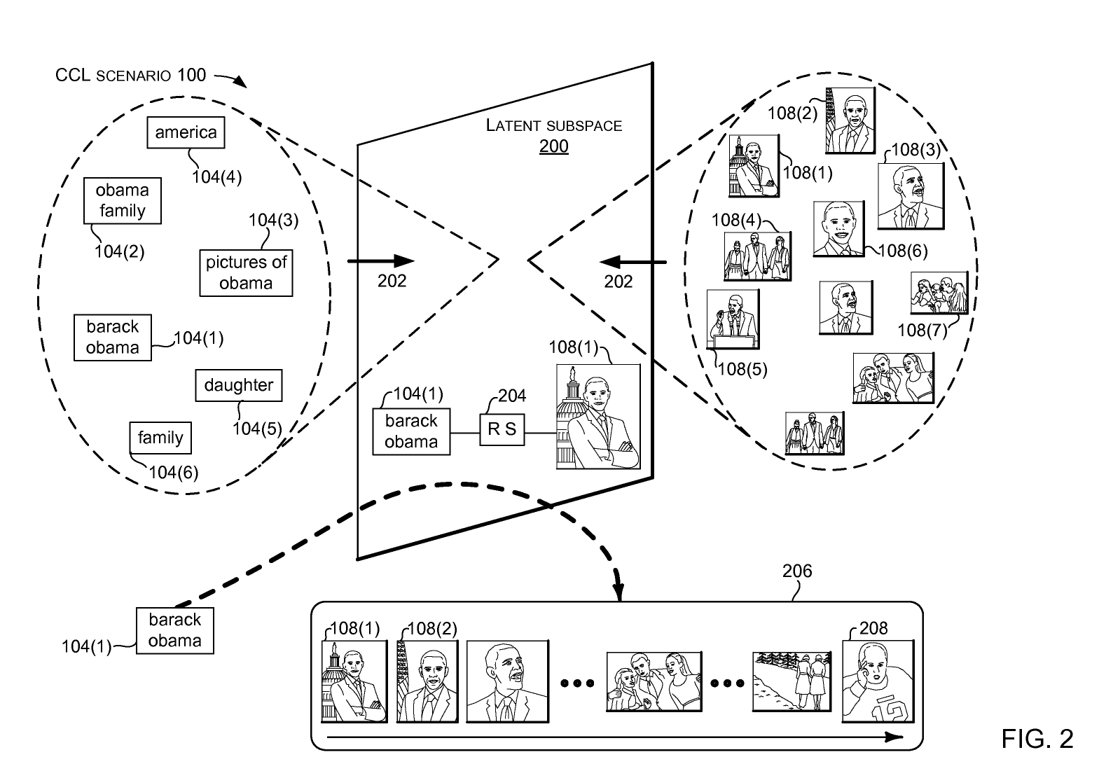

FIGS. 1 and 2 collectively illustrate an exemplary click-through-based cross-view learning (CCL) scenario 100. As shown in the example in FIG. 1, scenario 100 can include a textual query space 102 with textual queries 104 and a visual image space 106 with visual images 108. Scenario 100 can also include a click-through bipartite graph 110 and click-through-based cross-view learning mapping functions 112. FIG. 1 shows six textual queries 104(1-6) in the textual query space 102. For example, individual textual query 104(1) includes the words “barack obama,” textual query 104(2) includes the words “obama family,” etc. FIG. 1 also shows seven visual images 108(1-7) in the visual image space 106. Of course, the numbers of textual queries and visual images shown in FIG. 1 are not meant to be limiting. The textual query space and the visual image space can contain virtually any number of individual textual queries and/or visual images, respectively. In some cases parentheticals are utilized after a reference number to distinguish like elements. Use of the reference number without the associated parenthetical is generic to the element.

As shown in FIG. 1, textual queries 104 can be arranged graphically in the textual query space 102. In the textual query space, a link (e.g., link 114, link 116) between two textual queries can represent a similarity between the two textual queries (only two links are designated to avoid clutter on the drawing page). In FIG. 1, links between textual queries are shown with lines of different thicknesses (e.g., strengths). For example, link 114 between individual textual queries 104(1) and 104(3) can be represented by a relatively thick line and can suggest a relatively high similarity (e.g., relatively high strength association) between these textual queries. In contrast, link 116 between individual textual queries 104(1) and 104(2) can be relatively less thick than link 114, and can suggest a relatively lower similarity between these textual queries. Further, in this example, there is no link between textual queries 104(2) and 104(3), suggesting an even lower similarity between these two textual queries.

Also as shown in FIG. 1, visual images 108 can be arranged graphically in the visual image space 106. The visual image space can also include relatively thicker links (e.g., lines) between individual visual images 108, such as link 118 suggesting relatively higher similarity between visual images 108(1) and 108(2), and relatively thinner links, such as link 120 suggesting relatively lower similarity between visual images 108(3) and 108(4).

In some implementations, the graphical arrangement of the links (e.g., link 114, link 116) between individual textual queries 104 and/or the thicknesses/strengths of the links can constitute a structure of the textual query space 102. Similarly, the visual image space 106 can have a structure that can be represented by the graphical arrangement of the links (e.g., link 118, link 120) between individual visual images 108 and/or the thicknesses/strengths of the links.

In example click-through-based cross-view learning scenario 100, the click-through bipartite graph 110 can include click-through data 122 (e.g., “crowdsourced” human intelligence, click counts). The click-through data 122 can be associated with edges between individual textual queries 104 and individual visual images 108 (e.g., textual query-visual image pairs) in the click-through bipartite graph 110, indicating that a user clicked an individual visual image in response to an individual textual query. For example, in FIG. 1, the click-through bipartite graph 110 can show that visual image 108(1) was clicked 47 times in response to textual query 104(1). Stated another way, in this case “47” is an individual click-through data point for the textual query 104(1)-visual image 108(1) pair. Similarly, the click-through bipartite graph can show that visual image 108(4) was clicked 39 times in response to textual query 104(2), etc. The numbers “47” and “39” are provided as examples to aid in understanding of the click-through bipartite graph. Of course, other individual click-through data points are possible. In some cases, an individual click-through data point can be considered a cross-view distance between a textual query-visual image pair. The click-through bipartite graph can be constructed from search logs from a commercial image search engine, for example.

In some implementations, the click-through data 122 and the structures from the textual query space 102 and the visual image space 106 can be used to generate click-through-based cross-view learning mapping functions 112. The mapping functions 112 can be used to project (e.g., map) the textual queries 104 and the visual images 108 into a latent subspace, which will be described relative to FIG. 2. Referring to FIG. 1, line 124 can represent the use of cross-view distances related to click-through data 122 from the click-through bipartite graph 110 in the mapping functions 112. Also, lines 126 and 128 can represent a preservation of the structures from the textual query space 102 and visual image space 106, respectively, in the mapping functions. In some implementations, click-through-based cross-view learning mapping functions 112 can be trained on a large-scale, click-based visual image dataset. For example, a click-through based image search approach can be evaluated on a visual image dataset with millions of log records, which can be sampled from a one-year click log of a commercial image search engine.

FIG. 2 provides another view of click-through-based cross-view learning scenario 100. FIG. 2 includes a latent subspace 200, which can be considered a click-through-based structured latent subspace. Arrows 202 can represent the projection of textual queries 104 and visual images 108 into the latent subspace 200. In FIG. 2, only individual textual query 104(1) and individual visual image 108(1) are shown within the latent subspace due to constraints of the drawing page.

Referring to FIGS. 1 and 2, distances between the textual queries 104 and the visual images 108 can be mapped in the latent subspace 200 using the mapping functions 112. In some cases, the use of click-through data 122 in the mapping functions 112 can include consideration of specific click-through data points associated with textual query-visual image pairs in the click-through bipartite graph 110. For example, the click-through data point “47” between textual query 104(1) and visual image 108(1) can help determine a distance between this textual query 104(1)-visual image 108(1) pair in the latent subspace 200. Additionally, the graphical arrangement and/or the structure of links in the textual query space 102 and/or the visual image space 106 can be used to help determine a distance between textual queries 104 or visual images 108 in the latent subspace 200. Stated another way, mapping of individual textual queries and visual images in the latent subspace can be dependent on cross-view distances from click-through data and structure from the original spaces of the textual queries and visual images.

In some implementations, relevance scores (RS) 204 between textual query 104-visual image 108 pairs can be directly computed based on their mappings in the latent subspace 200. In some cases, the relevance scores can be the distances between the textual query-visual image pairs in the latent subspace. FIG. 2 shows a representative relevance score 204 between the individual textual query 104(1) and individual visual image 108(1).

The calculated relevance scores 204 for textual query 104-visual image 108 pairs can be sorted. Based on the sorted relevance scores, a ranked image search list 206 can be returned for any given textual query 104. For example, in FIG. 2, textual query 104(1) “barack obama” returned ranked image search list 206, which is a list of visual image results. The ranked image search list can be ranked according to relevance scores between each visual image in the list and textual query 104(1). In this case, within the ranked image search list, the visual images with highest relevance can be shown on the left side of the drawing page, and the ranking can descend in terms of relevance scores toward the right hand side. As such, visual image 108(1) can have a higher relevance score than visual image 108(2). In this case, visual image 208 can have a relatively low relevance score. Stated another way, visual image 208 can be an image of a man that is not Barack Obama. Therefore, in this case, it is unlikely that visual image 208 is relevant to textual query 104(1) “barack obama,” and/or unlikely that a user entering the textual query 104(1) “barack obama” would be interested in selecting visual image 208 from a list of visual image search results.

Referring to FIG. 1, note that the click-through data 122 for the textual query 104(1)-visual image 108(1) pair shows 47 clicks. The click-through data 122 for the textual query 104(1)-visual image 108(2) pair shows 50 clicks. In this example, the click-through data can suggest a stronger association between textual query 104(1) and visual image 108(2) than with visual image 108(1). However, in FIG. 2, visual image 108(1) appears to the left of visual image 108(2) in the ranked image search list 206, indicating that visual image 108(1) has a stronger association with textual query 104(1). This can be considered an example of the influence of the structure preservation of the textual query space 102 and/or the visual image space 106 in the mapped latent subspace 200. For example, mapping between textual queries 104 and visual images 108 in the latent subspace 200 can be based on both the click-through data 122 and the structures from the original spaces (e.g., textual query space 102 and visual image space 106). Therefore, the relevance scores 204 of textual query-visual image pairs are influenced by both the click-through data and the structures from the original spaces, and the click-through data alone (or the structures from the original spaces alone) may not determine and/or control relevance.

Additionally, relevance scores 204 can be computed between two textual queries 104 and/or between two visual images 108 based on distances mapped in the latent subspace 200. The mapped latent subspace can therefore be useful for comparing relevance between two textual queries, between two visual images, and/or between textual query-visual image pairs.

Note that in the example shown in FIG. 2, individual textual query 104(1) was used in the training of the mapping functions 112 and was also the textual query demonstrated with the mapped latent subspace 200. In some implementations, a mapped latent subspace can be used to generate a ranked image search list for a new or different textual query. For example, trained click-through based cross-view learning mapping functions could be used to map a new textual query into a mapped latent subspace. Relevance scores for visual images and/or a ranked image search list can then be generated for the newly mapped textual query.

In scenario 100 shown in FIGS. 1 and 2, two modalities (textual queries and visual images) were projected into a latent subspace, creating a click-through-based structured latent subspace for comparing the two modalities. Note that click-through based cross-view learning techniques can be applicable to comparing other seemingly disparate modalities as well. For example, click-through based cross-view learning techniques can be for comparing audio and/or video.

### Second Scenario Example

A second click-through-based cross-view learning scenario will now be described. In this second scenario, a click-through bipartite graph (such as click-through bipartite graph 110 as described relative to FIG. 1) can be defined that encodes user actions from a query log. Two learning components (e.g., mapping functions) of the click-through-based cross-view learning technique can be constructed, including cross-view distances from the click-through bipartite graph and structure preservation from the original textual query and visual image spaces. Finally, an algorithm for image search is described.

### Notation

In this example, [symbol] =(v,ε) can denote a click-through bipartite graph. v=Q ∪v can be a set of vertices, which can consist of a textual query set Q and a visual image set v. ε can be a set of edges between textual query vertices and visual image vertices. A number associated with an edge can represent a number of times a visual image was clicked in image search results of a particular textual query. In some cases, there can be n triads {qᵢ, vᵢ, cᵢ}ᵢ₌₁ⁿ generated from the click-through bipartite graph, where cᵢ can be the individual click-through data points (e.g., click counts) of visual image vᵢ in response to textual query qᵢ. In this case, Q={q₁, q₂, . . . qₙ}^{T}ε [symbol] ^{n×d}^{_{q}} and V={v₁, v₂, . . . vₙ}^{T}ε [symbol] ^{n×d}^{ᵥ} can denote the textual query and visual image feature matrix, where qᵢ and vᵢ can be the textual query and visual image feature of textual query qᵢ and visual image vᵢ, and d_{q} and dᵥ can be the feature dimensionality, respectively. The click matrix C can be a diagonal n×n matrix with diagonal elements as cᵢ.

### Cross-View Distance

A low-dimensional, latent subspace (e.g., common subspace) can exist for representation of textual queries and visual images. A linear mapping function can be derived from the latent subspace:

f(qᵢ)=qᵢW_{q}, and f(vᵢ)=vᵢWᵥ (1)

where d can be the dimensionality of the latent subspace, and W_{q}ε [symbol] ^{d}^{_{q}}^{×d} and Wᵥε [symbol] ^{d}^{ᵥ}^{×d} can be the transformation matrices that project the textual query semantics and visual image content into the latent subspace, respectively.

To measure relations between the textual query and visual image content, one example can be to measure a distance between their mappings in the latent subspace as:

$${min}_{{W}_{q} , {W}_{v}} tr ( {( {QW}_{q} - {VW}_{v} )}^{T} C ( {QW}_{q} - {VW}_{v} ) ) \\ s . t . {W}_{q}^{T} {W}_{q} = I , {W}_{v}^{T} {W}_{v} = I \qquad ( 2 )$$

where tr(•) can denote a trace function. The matrices W_{q} and Wᵥ can have orthogonal columns, i.e., W_{q}^{T}W_{q}=W_{V}^{T}Wᵥ=I, where I can be an identity matrix. The constraints can restrict W_{q} and Wᵥ to converge to reasonable solutions rather than go to 0, which can be essentially meaningless in practice.

Specifically, a click number (e.g., click count) of a textual query-visual image pair can be viewed as an indicator of their relevance. In the case of image search, search engines can display results as thumbnails. Users can see an entire image before clicking on it. As such, barring distracting images and user intent changes, users predominantly tend to click on images that are relevant to their query. Therefore, click data can serve as a reliable connection between textual queries and visual images. An underlying assumption can be that the higher the click number, the smaller the distance between the textual query and the visual image in the latent subspace.

To learn the latent subspace across different views, the distance can be intuitively incorporated as a regularization on the mapping matrices W_{q} and W_{y} weighted by the click number.

### Structure Preservation

Structure preservation or manifold regularization can be effective for semi-supervised learning and/or multiview learning. This regularizer can indicate that similar points (e.g., similar textual queries) in an original space (e.g., a textual query space) should be mapped to relatively close positions in the latent subspace. An estimation of underlying structure can be measured by appropriate pairwise similarity between training samples. Specifically, the estimation can be given by:

$${\sum }_{i , j = 1}^{n} {S}_{ij}^{q} {‖ {q}_{i} {W}_{q} - {q}_{j} {W}_{q} ‖}^{2} + {\sum }_{i , j = 1}^{n} {S}_{ij}^{v} {‖ {v}_{i} {W}_{v} - {v}_{j} {W}_{v} ‖}^{2} \qquad ( 3 )$$

where S^{q}ε [symbol] ^{n×n} and S^{v} Δ [symbol] ^{n×n} can denote affinity matrices defined on the textual queries and visual images, respectively. Under the structure preservation criterion, it is reasonable to reduce and potentially minimize Eq. (3), because it might incur a heavy penalty if two similar examples are mapped far away from each other.

The affinity matrices S^{q} and S^{v} can be defined many ways. In this case, the elements can be computed by Gaussian functions, for example:

$${S}_{ij}^{t} = \{ \begin{matrix}{e}^{- \frac{{‖ {t}_{i} - {t}_{j} ‖}^{2}}{{σ}_{t}^{2}}} & if {t}_{i} ∈ {N}_{k} ( {t}_{j} ) or {t}_{j} ∈ {N}_{k} ( {t}_{i} ) \\ 0 & otherwise\end{matrix} \qquad ( 4 )$$

where t ε {q, v} for simplicity, e.g., t can be replaced by any one of q and v. σ^{t} as the bandwidth parameters. Nₖ (tᵢ) can represent a set of k nearest neighbors of tᵢ.

By defining the graph Laplacian L^{t}=D^{t}−S^{t} for t ε {a, v}, where D^{t} can be a diagonal matrix with its elements defined as Dᵢⱼ^{t}=ΣⱼSᵢⱼ^{t}, Eq. (3) can be rewritten as:

tr((QW_{q})^{T}L^{q}(QW_{q})+tr((VWᵥ)^{T}L^{v}(VWᵥ)). (5)

By reducing and potentially minimizing this term, a similarity between examples in the original space can be preserved in the learned latent subspace. Therefore, this regularizer can be added in the framework of the click-through-based cross-view learning technique, potentially for optimization of the technique.

### Overall Objective

An overall objective function can integrate the distance between views in Eq. (2) and the structure preservation in Eq. (5). Hence the following optimization (e.g., potentially optimizing) problem may be obtained:

$${min}_{{W}_{q} , {W}_{v}} tr ( {( {QW}_{q} - {VW}_{v} )}^{T} C ( {QW}_{q} - {VW}_{v} ) ) + λ ( tr ( {( {QW}_{q} )}^{T} {L}^{q} ( {QW}_{q} ) ) + tr ( {( {VW}_{v} )}^{T} {L}^{v} ( {VW}_{v} ) ) ) , \\ s . t . {W}_{q}^{T} {W}_{q} = I , {W}_{v}^{T} {W}_{v} = I \qquad ( 6 )$$

where λ can be the tradeoff parameter. The first term is the cross-view distance, while the second term represents structure preservation.

For simplicity, L(W_{q},Wᵥ) can be denoted as the objective function in Eq. (6). Thus, the optimization problem can be rewritten as:

$${min}_{\{ {W}_{q} , {W}_{v} \}} L ( {W}_{q} {W}_{v} ) , s . t . {W}_{q}^{T} {W}_{q} = I , {W}_{v}^{T} {W}_{v} = I . \qquad ( 7 )$$

The optimization above can be a non-convex problem. Nevertheless, the gradient of the objective function with respect to W_{q} and Wᵥ can be easily obtained, and can be given by:

$$\{ \begin{matrix}{∇}_{{w}_{q}} L ( {W}_{q} , {W}_{v} ) = 2 {Q}^{T} C ( {QW}_{q} - {VW}_{v} ) + 2 λ {Q}^{T} {L}^{q} {QW}_{q} \\ {∇}_{{w}_{v}} L ( {W}_{q} , {W}_{v} ) = 2 {V}^{T} C ( {VW}_{v} - {QW}_{q} ) + 2 λ {V}^{T} {L}^{v} {VW}_{v}\end{matrix} . \qquad ( 8 )$$

### Optimization

In some implementations, Eq. (7) can represent a difficult non-convex problem due to the orthogonal constraints. In response, in some cases a gradient descent optimization procedure can be used with curvilinear search for a local optimal solution.

In individual iterations of the gradient descent procedure, given the current feasible mapping matrices {W_{q}, Wᵥ} and their corresponding gradients {G_{q}=∇W_{q}L(W_{q},Wᵥ), Gᵥ=}WᵥL(W_{q},Wᵥ)), the skew-symmetric matrices P_{q} and Pᵥ can be defined as:

P_{q}=G_{q}W_{q}^{T}−W_{q}G_{q}^{T},Pᵥ=GᵥWᵥ^{T}−WᵥGᵥ^{T}. (9)

A new point can be searched as a curvilinear function of a step size τ, such that:

$${F}_{q} ( τ ) = {( I + \frac{τ}{2} {P}_{q} )}^{- 1} ( I - \frac{τ}{2} {P}_{q} ) {W}_{q} , \\ {F}_{v} ( τ ) = {( I + \frac{τ}{2} {P}_{v} )}^{- 1} ( I - \frac{τ}{2} {P}_{v} ) {W}_{v} . \qquad ( 10 )$$

Then, it can be verified that F_{q}(τ) and Fᵥ(τ) lead to several characteristics. The matrices F_{q}(τ) and Fᵥ(τ) can satisfy (F_{q}(τ))^{T}F_{q}(τ)=(Fᵥ(τ))^{T}Fᵥ(τ)=I for all τ ε R. The derivatives with respect to τ can be given as:

$$\{ \begin{matrix}{F}_{q}^{′} ( τ ) = - {( I + \frac{τ}{2} {P}_{q} )}^{- 1} {P}_{q} ( \frac{{W}_{q} + {F}_{q} ( τ )}{2} ) \\ {F}_{v}^{′} ( τ ) = - {( I + \frac{τ}{2} {P}_{v} )}^{- 1} {P}_{v} ( \frac{{W}_{v} + {F}_{v} ( τ )}{2} )\end{matrix} . \qquad ( 11 )$$

In particular, some implementations can obtain F_{q}′ (0)=−P_{q}W_{q} and Fᵥ′(0)=−PᵥWᵥ. Then, {F_{q}(τ), Fᵥ(τ)}_{τ≧0} can be a descent curve. Some implementations can use the classical Armijo-Wolfe based monotone curvilinear search algorithm to determine a suitable step τ as one satisfying the following conditions:

L(F_{q}(τ),Fᵥ(τ))≦L(F_{q}(0),Fᵥ(0))+ρ₁τL_{τ}′(F_{q}(0),Fᵥ(0)),

L_{τ}′(F_{q}(τ),Fᵥ(τ))≧ρ₂L_{τ}′(F_{q}(0),Fᵥ(0)), (12)

where p₁ and p₂ can be two parameters satisfying 0<p₁<p₂<1. L_{τ}′ (F_{q}(τ),Fᵥ(τ)) can be the derivative of L with respect to τ and can be calculated by:

$${L}_{τ}^{′} ( {F}_{q} ( τ ) , {F}_{v} ( τ ) ) = - {Σ}_{t ∈ \{ q , v \}} tr ( {{R}_{t} ( τ )}^{T} {( I + \frac{τ}{2} {P}_{t} )}^{- 1} {P}_{t} ( \frac{{W}_{t} + {F}_{t} ( r )}{2} ) ) , \qquad ( 13 )$$

where Rₜ(τ)=∇_{w}_{ₜ}L(F_{q}(τ),Fᵥ(τ)) for t ε {q, v}. In particular,

$$\begin{matrix}{L}_{τ}^{′} ( {F}_{q} ( 0 ) , {F}_{v} ( 0 ) ) = - {Σ}_{t ∈ \{ q , v \}} tr ( {G}_{t}^{T} ( {G}_{t} {W}_{t}^{T} - {W}_{t} {G}_{t}^{T} ) {W}_{t} ) \\ = - \frac{1}{2} {‖ {P}_{q} ‖}_{F}^{2} - \frac{1}{2} {‖ {P}_{v} ‖}_{F}^{2}\end{matrix} \qquad ( 14 )$$

### Algorithm

After the optimization (e.g., potential optimization) of W_{q} and Wᵥ, the linear mapping functions defined in Eq. (1) can be obtained. With this, originally incomparable textual query and visual image modalities can become comparable. Specifically, given a test textual query-visual image pair, (\hat{q} ε [symbol] ^{d}^{_{q}}, \hat{v} ε [symbol] ^{d}^{ᵥ}), a distance value between the pair can be computed as:

r(\hat{q},\hat{v})=∥\hat{q}W_{q}−\hat{v}Wᵥ∥₂. (15)

This value can reflect how relevant the textual query is to the visual image, and/or how well the textual query describes the visual image, with lower numbers indicating higher relevance. For any textual query, sorting by its corresponding values for all its associated visual images can give the retrieval ranking for these visual images. In this case, the algorithm is given in Algorithm 1.

Algorithm 1: Click-through-based Cross-view Learning
(CCL)

| | |
|---|---|
| 1: | Input: 0 < μ < 1,0 < ρ₁ < ρ₂ < 1, ε ≧ 0, and initial W_{q} and W_{q}. |
| 2: | for iter = 1 to Tₘₐₓ do |
| 3: | compute gradients G_{q} and Gᵥ via Eq.(8). |
| 4: | if \|\| G_{q} \|\|_{F}² +\|\| Gᵥ \|\|_{F}²≦ ε then |
| 5: | exit. |
| 6: | end if |
| 7: | compute P_{q} and Pᵥ by using Eq.(9). |
| 8: | compute L_{τ}′(F_{q}(0), Fᵥ(0)) according to Eq.(14). |
| 9: | set τ = 1. |
| 10: | repeat |
| 11: | τ = μτ |
| 12: | compute F_{q}(τ) and Fᵥ(τ) via Eq.(10). |
| 13: | compute L_{τ}′(F_{q}(τ), Fᵥ(τ)) via Eq.(13). |
| 14: | until Armijo-Wolfe conditions in Eq.(12) are satisfied |
| 15: | update the transformation matrices: |
| | W_{q} = F_{q}(τ) |
| | Wᵥ = Fᵥ(τ ) |
| 16: | end for |
| 17: | Output: |
| | distance function: ∀\hat{q}, \hat{v}, r(\hat{q}, \hat{v}) = \|\| \hat{q}W_{q} − \hat{v}Wᵥ \|\|₂. |

### Complexity Analysis

The time complexity of the click-through-based cross-view learning technique can depend on computation of G_{q}, Gᵥ, P_{q}, Pᵥ, F_{q}(τ), Fᵥ(τ), and Lᵣ′Fq(τ), Fv(τ)). The computation complexity of G_{q} and Gᵥ can be O(n²×d_{q}) and O(n²×dᵥ), respectively. P_{q} and Pᵥ can take O(d_{q}²×d) and O(dᵥ²×d).

A matrix inverse

$${( I + \frac{τ}{2} {P}_{q} )}^{- 1} and {( I + \frac{τ}{2} {P}_{v} )}^{- 1}$$

can dominate the computation of F_{q}(τ) and Fᵥ(τ) in Eq. (10). By forming P_{q} and Pᵥ as an outer product of two low-rank matrices, the inverse computation cost can decrease significantly. As defined in Eq. (9), P_{q}=G_{q}W_{q}^{T}−W_{q}−W_{q}G_{q}^{T} and Pᵥ=GᵥWᵥ^{T}−WᵥGᵥ^{T}, P_{q} and Pᵥ can be equivalently rewritten as P_{q}=X_{q}Y_{q}^{T} and Pᵥ=XᵥYᵥ^{T}, where X_{q}=[G_{q},W_{q}], Y_{q}=[W_{q},−G_{q}] and Xᵥ=[Gᵥ,Wᵥ], Yᵥ=[Wᵥ,−Gᵥ]. According to a Sherman-Morrison-Woodbury formula, for example:

(A+αXY^{T})⁻¹=A⁻¹−αA⁻¹X(I+αY^{T}A⁻¹X)⁻¹Y^{T}A⁻¹,

the matrix inverse

$${( I + \frac{τ}{2} {P}_{q} )}^{- 1}$$

can be re-expressed as:

$${( I + \frac{τ}{2} {P}_{q} )}^{- 1} = I - \frac{τ}{2} {{X}_{q} ( I + \frac{τ}{2} {Y}_{q}^{T} {X}_{q} )}^{- 1} {Y}_{q}^{T} .$$

Furthermore, F_{q}(τ) can be rewritten as:

$${F}_{q} ( τ ) = {W}_{q} - τ {{X}_{q} ( I + \frac{τ}{2} {Y}_{q}^{T} {X}_{q} )}^{- 1} {Y}_{q}^{T} {W}_{q} .$$

For Fᵥ(τ), the click-through-based cross-view learning technique can get the corresponding conclusion. Since d<<d_{q} can be typical in some cases, the cost of inverting

$$( I + \frac{τ}{2} {Y}_{q}^{T} {X}_{q} ) ∈ {ℝ}^{2 d \times 2 d}$$

can be much lower than inverting

$$( I + \frac{τ}{2} {P}_{q} ) ∈ {ℝ}^{{d}_{q} \times {d}_{q}} .$$

The inverse of

$${( I + \frac{τ}{2} {Y}_{q}^{T} {X}_{q} )}^{- 1}$$

can take O(d³), thus the computation complexity of F_{q}(τ) can be O(d_{q}d²)+O(d³). Similarly, Fᵥ(τ) can be O(dᵥd²)+O(d³). The work of computing L^{r}′(τ),Fv(τ)) can have a cost of O(n²×d_{q})+O(n²×dᵥ)+O(d_{q}²)+O(dᵥd²)+O(d³).

As d<<d_{q},dᵥ<<n, the overall complexity of the Algorithm 1 can be Tₘₐₓ×T×O(n²×max(d_{q},dᵥ)), where T can be a number of searching for appropriate τ which can satisfy Armijo-Wolfe conditions and can be less than ten in some cases. Given a training of W_{q} and Wᵥ on one million {query, image, click} triads with dᵥ=1,024 and dq=10,000 for example, this algorithm can take around 32 hours on the server with Intel E5-2665@2.40 GHz CPU and 128 GB RAM.

To summarize, click-through-based cross-view learning techniques can learn the multi-view distance between a textual query and a visual image by leveraging both click-through data and subspace learning techniques. The click-through data can represent the click relations between textual queries and visual images, while subspace learning can aim to learn a common latent subspace between multiple modalities. Click-through-based cross-view learning techniques can be used to solve the problem of seemingly incomparable modalities in a principle way. Specifically, two different linear mappings can be used to project textual queries and visual images into the latent subspace. The mappings can be learned by jointly reducing the distance of observed textual query-visual image pairs on a click-through bipartite graph, and also preserving inherent structure in original spaces of the textual queries and visual images. Moreover, orthogonal assumptions on the mapping matrices can be made. Then, mappings can be obtained efficiently through curvilinear search. An l₂ norm can be taken between the projections of textual query and visual image in the latent subspace as an instant function to measure the relevance of a textual query-visual image pair.

### Extensions

Although only the distance function between textual queries and visual images on the learned mapping matrices is presented in Algorithm 1, the optimization actually can also help learning of query-query and image-image distances. Similar to the distance function between a textual query and a visual image, the distance between a textual query and another textual query, or a visual image and another visual image, can be computed as:

(∀\hat{q}, q̅,r(\hat{q}, q̅)=∥\hat{q}W_{q}− q̅W_{q}∥₂ and ∀\hat{v}, v̅,r(\hat{v}, v̅)=∥\hat{v}Wᵥ−\hat{v}Wᵥ∥₂,

respectively. Furthermore, the obtained distance can be applied for several information retrieval (IR) applications, e.g., query suggestion, query expansion, image clustering, image classification, etc.

### Example Use-Case Scenario

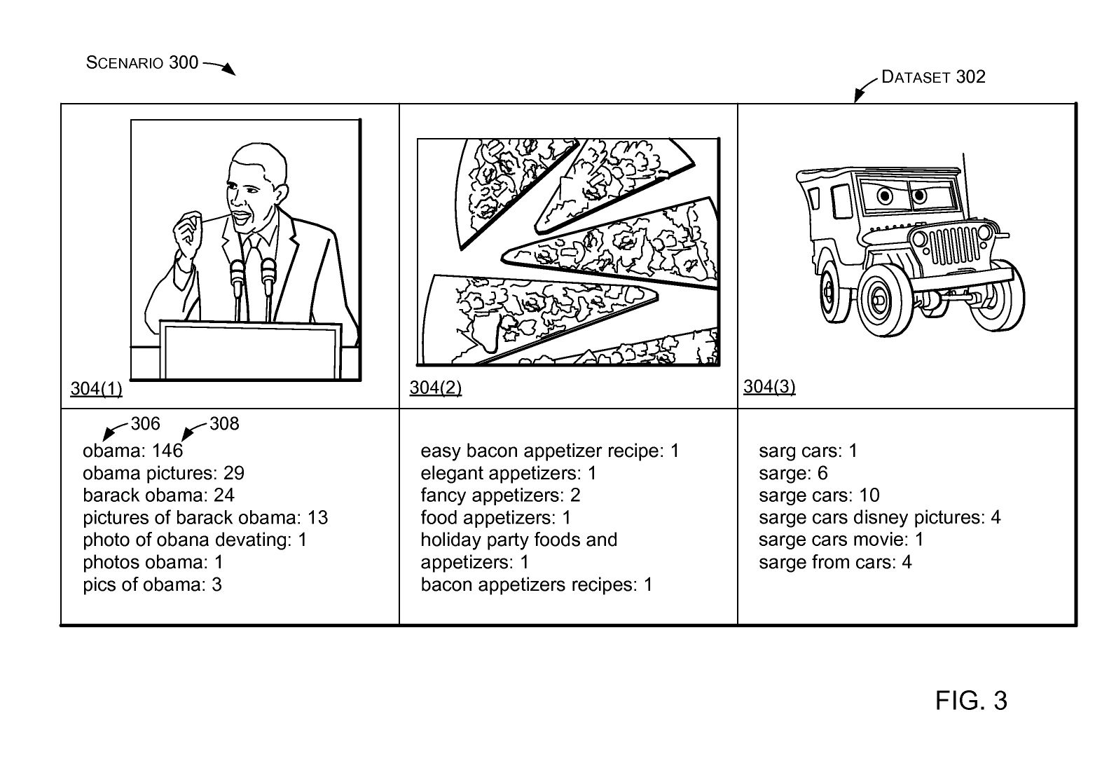

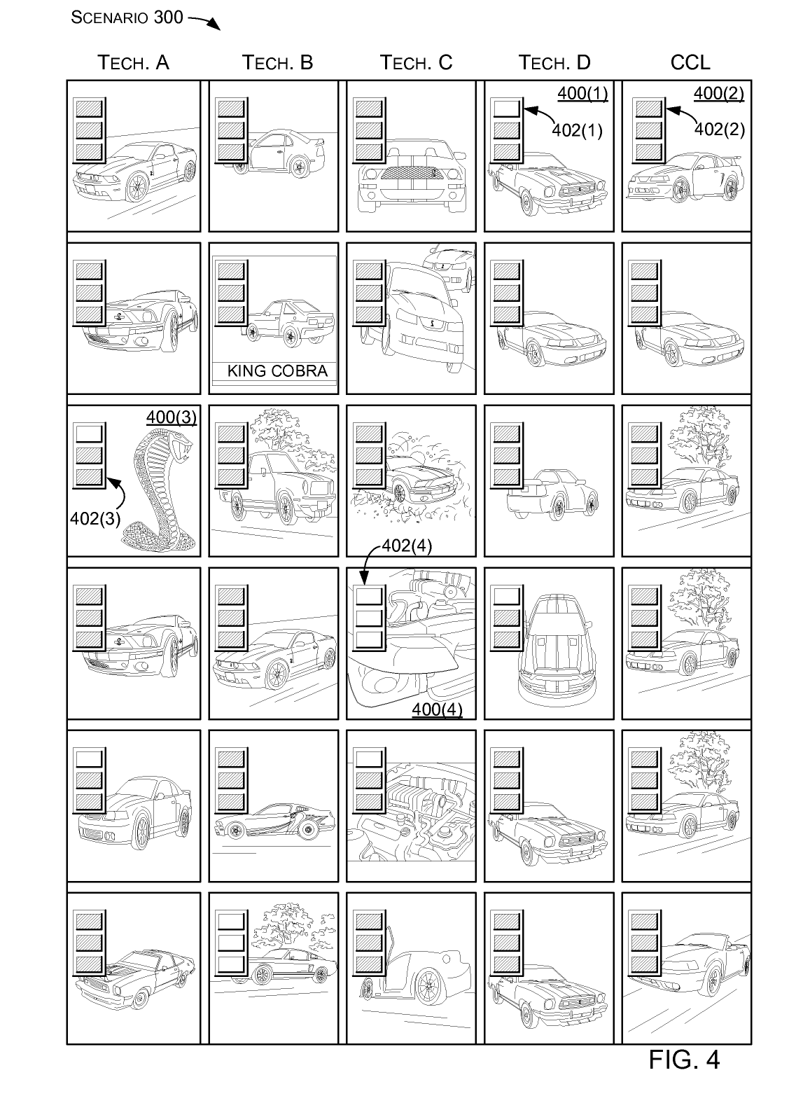

FIGS. 3-6 illustrate an example use-case scenario 300 for click-through-based cross-view learning techniques. FIG. 3 illustrates a portion of an example search dataset used to train click-through-based cross-view learning techniques in scenario 300. FIGS. 4-6 provide example performance results from scenario 300. (To provide effective examples, illustrations and search terms in FIGS. 4-6 may relate to trademarked material. Applicant does not make any claim of ownership to this material and its utilization is considered fair use in the present discussions).

### Example Search Dataset

As shown in FIG. 3, example use-case scenario 300 can include an example search dataset 302. In FIG. 3, three example visual images 304 from the example search dataset are shown, specifically visual image 304(1), 304(2), and 304(3). Each of the visual images 304 can have associated textual queries 306 (only one textual query is designated to avoid clutter on the drawing page). In FIG. 3 the textual queries are shown below the visual images with which they are associated. The textual queries can have corresponding individual click-through data points 308 (e.g., click counts), which are shown in-line with the textual queries. In this case, the individual click-through data points 308 in FIG. 3 are similar to individual click-through data points of the click-through data 122 shown in the click-through bipartite graph 110 in FIG. 1. Referring to FIG. 3, for instance, visual image 304(1) can have seven associated textual queries 306, located below visual image 304(1). The first listed textual query 306 is “obama,” which has a corresponding individual click-through data point 308 of “146.” Therefore, in this instance, visual image 304(1) was clicked 146 times by users in search results returned for the textual query 306 “obama.” The individual click-through data points in FIG. 3 are provided for understanding to the example, other numbers are contemplated for individual click-through data points 308. Note that in this case, the visual images 304 do not include surrounding text or description.

In some implementations, the example search dataset 302 can be used to train click-through-based cross-view learning techniques and/or other techniques. In some cases, the example search dataset can be a large-scale, click-based image dataset (e.g., the “Clickture” dataset). The example search dataset can entail two parts, for example a training set and a development set. In one example, the training set can consist of many {query, image, click} triads (e.g., millions of triads), where “query” can be a textual word or phrase, “image” can be a base64 encoded JPEG image thumbnail (for example), and “click” can be an integer which is no less than one. In this example, there can be potentially millions of distinct queries and millions of unique images of the training set.

In the development set, there can be potentially thousands of {query, image} pairs generated from hundreds of queries, for example. In some cases, each image to a corresponding query can be manually annotated on a three-point ordinal scale: “Excellent,” “Good,” and “Bad.” The training set can be used for learning a latent subspace (such as latent subspace 200 described relative to FIG. 2), while the development set can be used for performance evaluation of a click-through-based cross-view learning technique and/or other techniques.

### Performance Comparison

As shown in FIGS. 4-6, in example use-case scenario 300, a click-through-based cross-view learning (CCL) technique and other techniques can be evaluated on the example search dataset 302. In some cases, the evaluation can show whether click-through-based cross-view learning techniques can be used to improve visual image search results in comparison to the other techniques. Specifically, the example search dataset can be used as “labeled” data for textual queries (such as textual queries 104 in FIGS. 1 and 2) and to train a ranking model. Performance evaluation can include estimating relevance of a visual image (such as visual images 108 in FIGS. 1 and 2) and a textual query for each test textual query-visual image pair. Also, for each textual query, visual images can be ordered based on the prediction scores (e.g., relevance) returned by the trained ranking model.

In example use-case scenario 300, the words in textual queries can be taken as “word features.” For any textual query, words can be stemmed and/or words can be removed. With word features, each textual query can be represented by a ‘tf’ vector in a textual query space (such as textual query space 102 shown in FIG. 1). A top number of most frequent words can be used as a word vocabulary. In one example, deep neural networks (DNN) can be used to generate an image representation in a visual image space (such as visual image space 106 shown in FIG. 1). In this example the visual image space can be a 1024-dimensional feature vector. In one specific example, DNN architecture can be denoted as Image-C64-P-N-C128-P-N-C192-C192-C128-P-F4096-F1024-F1000, which contains five convolutional layers (denoted by C following the number of filters) while the last three are fully-connected layers (denoted by F following the number of neurons); the max-pooling layers (denoted by P) follow the first, second and fifth convolutional layers; and local contrast normalization layers (denoted by N) follow the first and second max-pooling layers. For example, the weights of DNN can be learned on ILSVRC-20101, which is a subset of ImageNet2 dataset. For a visual image, its representation can be the neuronal responses of the layer F1024 by inputting the visual image into the learned DNN. While DNN is applied here, other techniques can be utilized, such as color moment, wavelet texture, and/or bag-of-visual-words, among others.

Click-through-based Cross-view Learning (CCL), such as the implementation described above in Algorithm 1, can be compared to other example techniques in use-case scenario 300. The other example Techniques (A-D) can include:

Technique A: N-Gram support vector machine (SVM) Modeling, or N-Gram SVM

Technique B: Canonical Correlation Analysis (CCA)

Technique C: Partial Least Squares (PLS)

Technique D: Polynomial Semantic Indexing (PSI)

In example use-case scenario 300, N-Gram SVM can be considered a baseline without low-dimensional, latent subspace learning, thus in N-Gram SVM the relevance score can be predicted on an original visual image. For the other four techniques in this example, which include latent subspace learning, the dimensionality of the latent subspace can be in the range of {40, 80, 120, 160} in this implementation. The k nearest neighbors preserved in Eq. (4) can be selected within {100, 500, 1000, 1500, 2000}. The tradeoff parameter λ in the overall objective function can be set within {0.1, 0.2, . . . , 1.0}. Some implementations can set μ=0.3, ρ₁ 1=0.2, and ρ₂ 2=0.9 in the curvilinear search by using a validation set.

In this example, for performance evaluation of visual image search, a Normalized Discounted Cumulative Gain (NDCG) technique can be adopted, which can take into account a measure of multi-level relevancy as the performance metric. Given an image ranked list, the NDCG score at the depth of d in the ranked list can be defined by:

$$NDCG @ d = {Z}_{d} {\sum }_{j = 1}^{d} \frac{{2}^{{r}^{j}} - 1}{log ( 1 + j )} \qquad ( 16 )$$

where r^{j}={Excellent=3, Good=2, Bad=0} can be the manually judged relevance for each image with respect to the query. Z_{d} can be a normalizer factor to make the score for d Excellent results 1. The final metric can be the average of NDCG@d for all queries in the test set.

In this example, as the step τ can be chosen to satisfy the Armijo-Wolfe conditions to achieve an approximate minimizer of L(F_{q}(τ),Fv(τ)) in Algorithm 1 instead of finding the global minimization due to its computational expense, the average overall objective value of Eq. (6) for one textual query-visual image pair versus iterations can be depicted to illustrate the convergence of the algorithm. In some cases, the value may not decrease as the iterations increase at all the dimensionality of the latent subspace. Specifically, after 100 iterations, the average objective value between query mapping and image projection can be around 10 when the latent subspace dimension is 40. Thus, the experiment can verify that Algorithm 1 can provide improved results and potentially reach a reasonable local optimum.

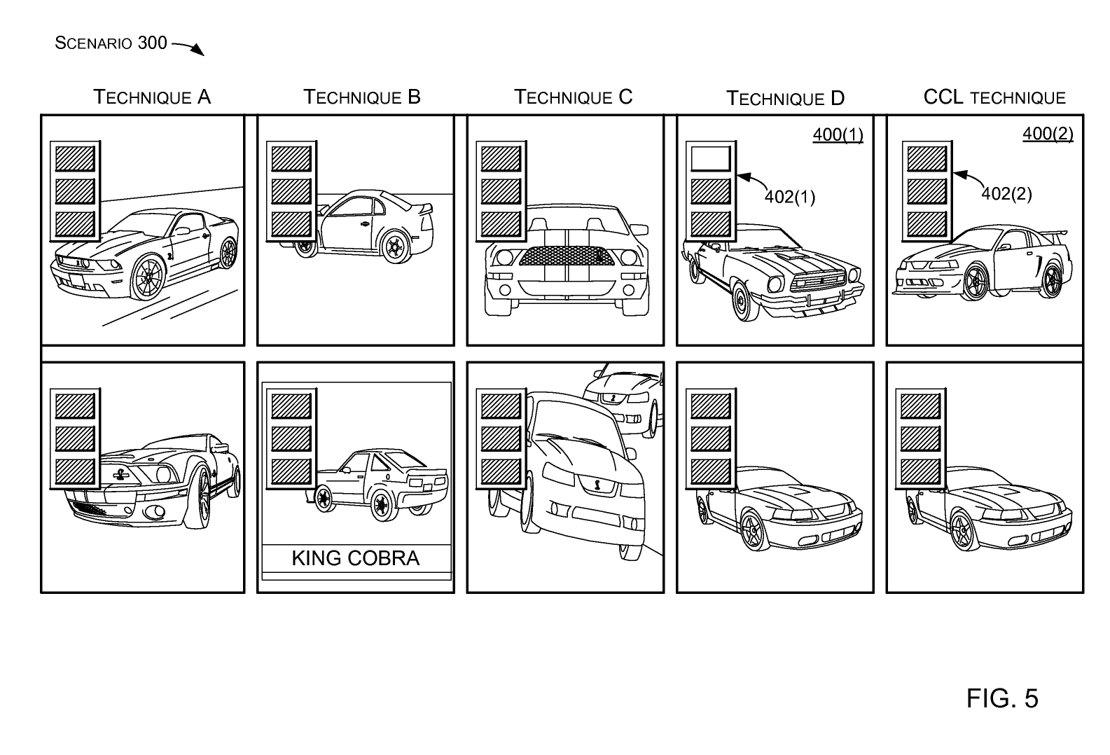

FIGS. 4 and 5 illustrate example visual image search results 400 for the example use-case scenario 300. In FIGS. 4 and 5, visual image search results are shown for a single textual query, “mustang cobra.” In FIGS. 4 and 5, each column represents search results from one of the example techniques trained as described above (Techniques A-D and the click-through-based cross-view learning (CCL) technique). FIG. 4 shows the top six visual image search results returned for “mustang cobra” by the five example techniques. Only the top six search results are shown in FIG. 4 (e.g., six rows of results are shown) due to the limitations of the drawing page. In FIG. 4, not all search results are designated to avoid clutter on the drawing page. FIG. 5 provides a closer view of the top two visual image search results returned for “mustang cobra” by the same five example techniques. (Please note that the term ‘mustang cobra’ may be trademarked and the assignee of this patent is not implying any rights in the term. Instead, the term is used herein as a fair use example of a real-life search term that is useful for explaining the inventive concepts. The phrase ‘Barack Obama’ is used in a similar manner).

In the example shown in FIGS. 4 and 5, each visual image search result 400 includes a relevance scale 402 at the top left corner of the search result. In this case, the relevance scales are shown as 3 boxes which can be shaded or not shaded (e.g., non-shaded, blank). In this example, shaded boxes can represent higher relevancy. For instance, visual image search result 400(1) can be considered the top search result returned by Technique D (e.g., most relevant visual image according to Technique D), while visual image search result 400(2) can be considered the top search result returned by the CCL technique. In this instance (viewed more easily in FIG. 5), search result 400(1) shows a lower relevancy than search result 400(2), since the relevance scale 402(1) of search result 400(1) has two shaded boxes, while the relevancy scale 402(2) for search result 400(2) has three shaded boxes.

In some cases, higher relevancy as shown by the relevance scales 402 can indicate that a certain technique has performed better than another technique in terms of returning relevant visual image search results 400 for the given textual query. For instance, in the example shown in FIGS. 4 and 5, the relevance scales 402 for the CCL technique include three shaded boxes for all of the top six visual image search results 400 (shown but not designated). Since the search results for each of the alternative Techniques A-D include at least one relevance scale 402 with at least one non-shaded box, it can be concluded that the CCL technique has outperformed the alternative Techniques A-D in this example use-case scenario 300.

In some cases, relevance can be considered a measure of how similar visual image search results are to each other for a given technique. For example, in the column representing results from Technique A, search result 400(3) appears as a visual image of a cobra (e.g., a snake, not a car). The visual image of the cobra is not similar to the other visual images in the column. The associated relevance scale 402(3) includes a non-shaded box. In another example, in the column representing results from Technique C, search result 400(4) appears as a visual image of an engine. The visual image of the engine is not similar to the other visual images in the column. The associated relevance scale 402(4) includes no shaded boxes. In these cases, Techniques A and C could be viewed as under-performing in part due to dissimilarity among their top search results. In some implementations, similarity of returned search results can be an effect of the structure preservation regularization term in the overall objective of the click-through-based cross-view learning technique, described above (e.g., Eq. (5)). The structure preservation regularization term can restrict similar images in the original visual image space (such as visual image space 106 in FIGS. 1 and 2) to remain close in the low-dimensional latent subspace (such as latent subspace 200 in FIG. 2). Therefore, the ranks of such similar images can be likely to be moved up in returned search results.

In general, use of click-through data can help bridge a user intention gap for image search. The user intention gap can relate to difficulty in knowing a user's intent based on textual query keywords, especially for ambiguous queries. The user intention gap can lead to biasing or error in manual annotation of relevance of textual query-visual image pairs by human labelers. For example, given the textual query “mustang cobra,” experts can tend to label images of animals “mustang” and/or “cobra” as highly relevant. However, empirical evidence suggests that most users entering the textual query “mustang cobra” to a search engine wish to retrieve images of a specific car named “Mustang Cobra.” The experts' labels might therefore be erroneous. Such factors can bias a training set and human ranking can be considered sub-optimal. On the other hand, click-through data can provide an alternative to address the user intention gap problem. In an image search engine, users can browse visual image search results before clicking a specific visual image. A user's decision to click on a visual image is likely dependent on the relevancy of the visual image. Therefore, the click-through data can serve as a reliable and implicit feedback for visual image search. Most of the clicked visual images might be relevant to the given textual query judged by the real users.

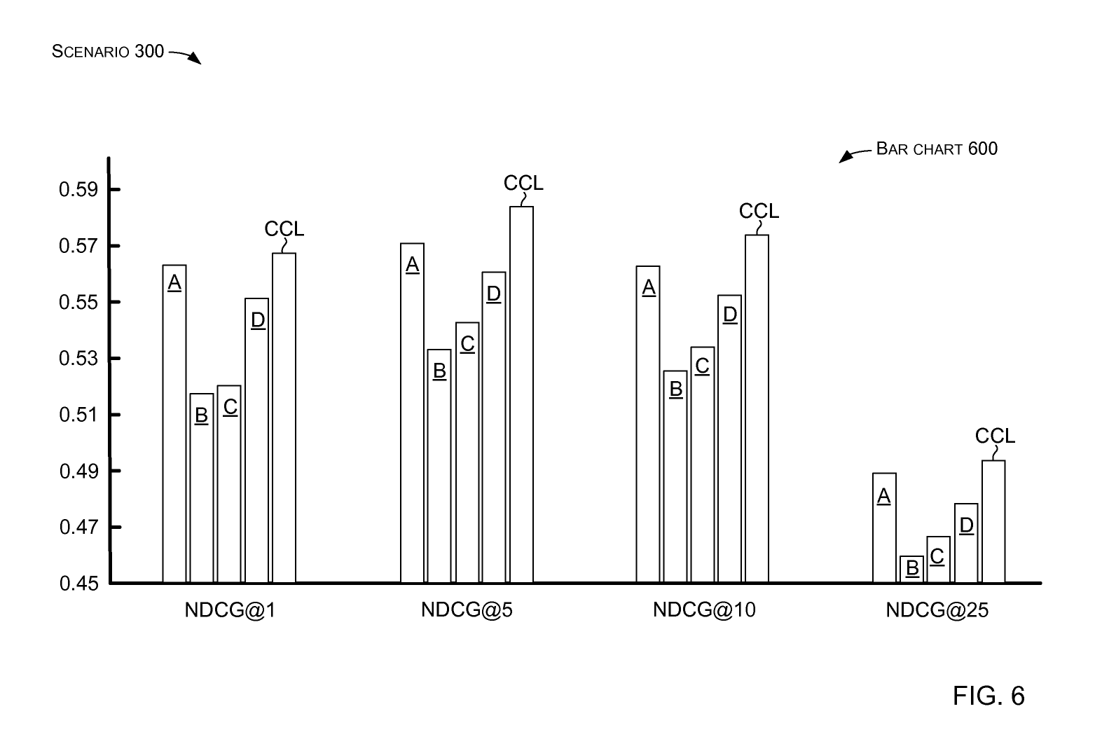

In the example use-case scenario 300, performance of the click-through-based cross-view learning (CCL) technique and example alternative Techniques A-D can be measured with the Normalized Discounted Cumulative Gain (NDCG) technique described above relative to Eq. (16). FIG. 6 shows an example bar chart 600 of results from the NDCG technique for example use-case scenario 300. In this example, bar chart 600 includes NDCG scores for Techniques A-D and the CCL technique. The NDCG scores can be given for depths of 1, 5, 10, and 25 in a ranked list for visual image search results. For example, in bar chart 600, “NDCG@1” includes bars representing scores for each Technique A-D and CCL for the first visual image returned (e.g., a depth of 1 in the ranked list). Similarly, “NDCG@5” includes bars representing scores for each Technique A-D and CCL for the fifth visual image returned, etc.

In bar chart 600, the bars can represent NDCG scores averaged for over 1000 textual queries. In this case, the prediction for Technique A is performed on original visual image features of 1,024 dimensions, for example. For Techniques B-D and CCL, the performances are given by choosing 80 as the dimensionality of the latent subspace, in this case.

In the example shown in FIG. 6, the CCL technique is seen to outperform Techniques A-D across different depths of NDCG. In particular, in the case shown in bar chart 600, the CCL technique is shown to achieve a NDCG score of 0.5738 at a depth of 10 in the ranked list. This can be interpreted as an improvement over Technique A with respect to the NDCG score. Additionally, by learning a low-dimensional latent subspace, the dimension of the mappings of textual query and visual image can be reduced by several orders of magnitude. Furthermore, by incorporating structure preservation, the CCL technique can produce a performance boost as compared to Techniques B and D. The results shown in the example of bar chart 600 indicate an advantage of minimizing distance between views in the latent subspace and preserving similarity in the original space simultaneously.

The example results shown in bar chart 600 also show a performance gap between Techniques B and D. Though both example techniques attempt to learn linear mapping functions for forming a latent subspace, they are different in the way that Technique D learns cosine as a similarity function, and Technique B learns dot product. As indicated by the results shown in bar chart 600, increasing (e.g., potentially maximizing) a correlation between mappings in the latent subspace can lead to better performance. Moreover, Technique C, which utilizes click-through data as relative relevance judgments rather than absolute click numbers, can be superior to Technique B, but still shows lower NDCG scores than the CCL technique in this case. Another observation is that performance gain by the CCL technique is almost consistent when going deeper into the ranked list, which can represent another confirmation of effectiveness of the CCL technique in this case.

In some cases, the CCL technique is robust to changes in the dimensionality of the latent subspace. Stated another way, the CCL technique can be shown to outperform example Techniques A-D for different dimensionalities of the latent subspace. Thus, the example CCL techniques can provide a solution to the technical problem of identifying appropriate images for web queries. The solution can enhance the end user experience while effectively utilizing resources on the server side (e.g., providing meaningful results per processing cycle).

### Example System

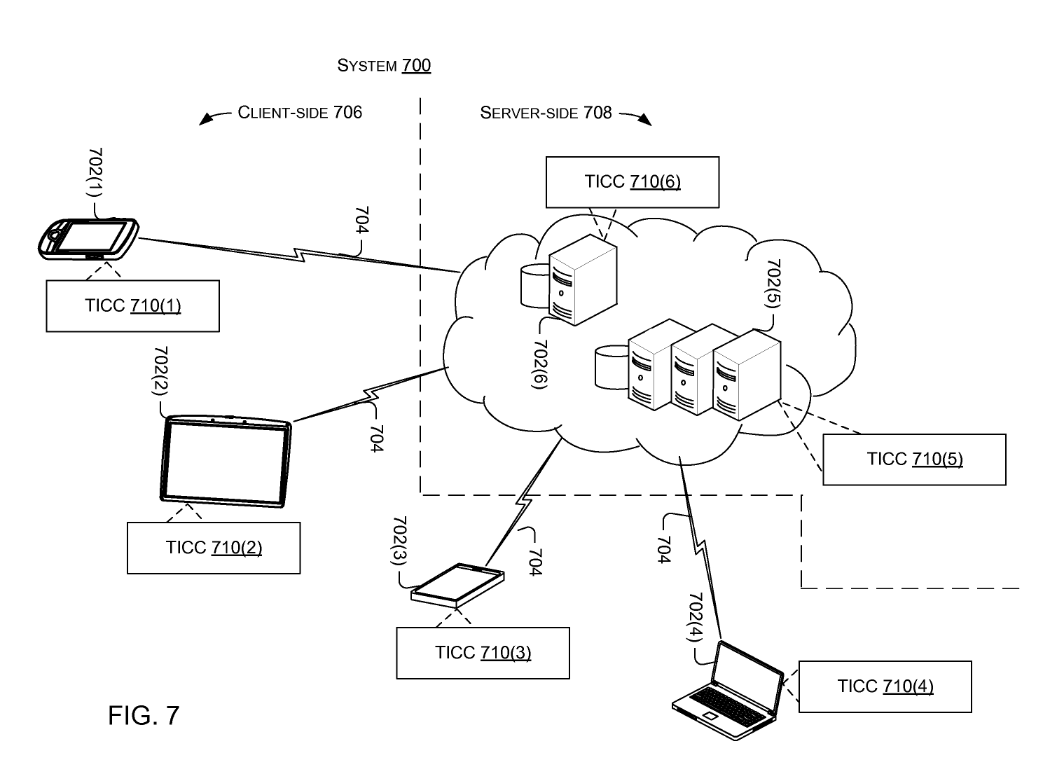

FIG. 7 shows a system 700 that can accomplish click-through-based cross-view learning (CCL) techniques. For purposes of explanation, system 700 includes four devices 702(1-4) that can communicate with other devices 702(5-6) that can provide a service, such as a search engine service. (The number of illustrated devices is, of course, intended to be representative and non-limiting). Devices 702(1-4) can communicate with devices 702(5-6) via one or more networks (represented by lightning bolts 704). In some cases parentheticals are utilized after a reference number to distinguish like elements. Use of the reference number without the associated parenthetical is generic to the element.

For purposes of explanation, devices 702(1-4) can be thought of as operating on a client-side 706 (e.g., they are client-side devices). Devices 702(5-6) can be thought of as operating on a server-side 708 (e.g., they are server-side devices, such as in a datacenter or server farm). The server-side devices can provide various remote services, such as search functionalities, for the client-side devices. In some implementations, each device 702 can include an instance of a text-image correlation component (TICC) 710. This is only one possible configuration and other implementations may include the server-side text-image correlation components 710(5-6) but eliminate the client-side text-image correlation components 710(1-4), for example. Other implementations may be accomplished on a single, self-contained device, such as on a single client-side device.

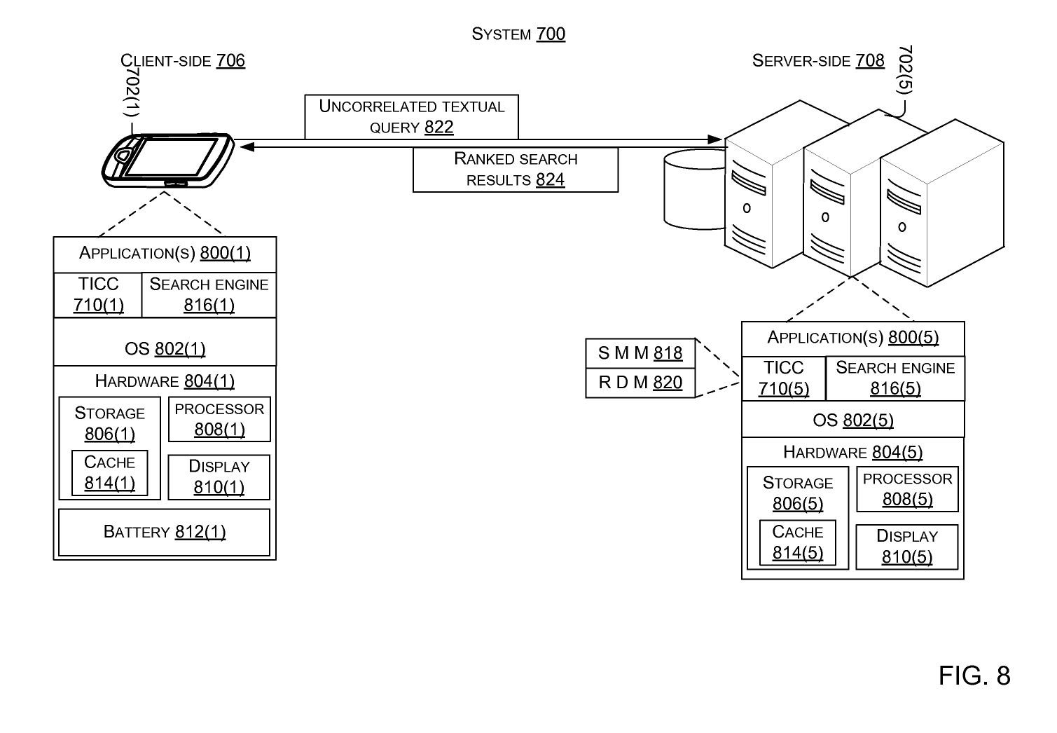

FIG. 8 shows additional details relating to components of client-side device 702(1) (representative of devices 702(1-4)) and server-side device 702(5) (representative of devices 702(5-6)). Individual devices 702 can support an application layer 800 running on an operating system (OS) layer 802. The operating system layer can interact with a hardware layer 804. Examples of hardware in the hardware layer can include storage media or storage 806, processor(s) 808, a display 810, and/or battery 812, among others. Storage 806 can include a cache 814. Note that illustrated hardware components are not intended to be limiting and different device manifestations can have different hardware components.

Text-image correlation component 710 can function in cooperation with application(s) layer 800 and/or operating system layer 802. For instance, text-image correlation component 710 can be manifest as an application or an application part. In one such example, the text-image correlation component 710 can be an application part of (or work in cooperation with) a search engine application 816.

From one perspective, individual devices 702 can be thought of as a computer. Processor 808 can execute data in the form of computer-readable instructions to provide a functionality. Data, such as computer-readable instructions and/or user-related data, can be stored on storage 806, such as storage that can be internal or external to the computer. The storage can include any one or more of volatile or non-volatile memory, hard drives, flash storage devices, and/or optical storage devices (e.g., CDs, DVDs etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some configurations, individual devices 702 can include a system on a chip (SOC) type design. In such a case, functionality provided by the computer can be integrated on a single SOC or multiple coupled SOCs. One or more processors can be configured to coordinate with shared resources, such as memory, storage, etc., and/or one or more dedicated resources, such as hardware blocks configured to perform certain specific functionality. Thus, the term “processor” as used herein can also refer to central processing units (CPUs), graphical processing units (CPUs), controllers, microcontrollers, processor cores, or other types of processing devices.

Generally, any of the functions described herein can be implemented using software, firmware, hardware (e.g., fixed-logic circuitry), manual processing, or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU or CPUs). The program code can be stored in one or more computer-readable memory devices, such as computer-readable storage media. The features and techniques of the component are platform-independent, meaning that they may be implemented on a variety of commercial computing platforms having a variety of processing configurations.

The text-image correlation component 710 can include a subspace mapping module (S M M) 818 and a relevance determination module (R D M) 820. Briefly, these modules can accomplish specific facets of text-image correlation. The subspace mapping module 818 can be involved in learning mapping functions that can be used to map a latent subspace. The relevance determination module 820 can be involved in determining relevance between the textual queries and the visual images.

In some implementations, the subspace mapping module 818 can use click-through data related to textual queries and visual images to learn mapping functions, such as described relative to FIG. 1. The subspace mapping module can also preserve a structure from an original textual query space and another structure from an original visual image space in the mapping functions, also described relative to FIG. 1.

In some implementations, the relevance determination module 820 can use the mapping functions produced by the subspace mapping module 818 to project textual queries and/or visual images into a latent space, such as described relative to FIG. 2. The relevance determination module can also calculate distances between the textual queries and the visual images in the latent subspace. Relevance can be determined based on the mapping of the latent subspace. In some cases, distances determined by the relevance determination module can be considered relevance scores between the textual queries and the visual images.

Referring to FIG. 7, an instance of subspace mapping module 818 and a relevance determination module 820 illustrated in FIG. 8 may be located on different individual devices 702. In this case, the subspace mapping module may be part of the text-image correlation component 710(6) on device 702(6). In this example, the subspace mapping module on device 702(6) may train or learn click-through-based cross-view learning mapping functions. The subspace mapping module may output the mapping functions for use by other devices. In this example, the relevance determination module may be part of the text-image correlation component 710(5) on device 702(5). The relevance determination module may receive the mapping functions from device 702(6). The relevance determination module may use the mapping functions to map distances between a new query and visual images in the latent subspace. In some cases, the relevance determination module on a device 702 can receive the mapping functions and also a learned (e.g., trained) latent subspace from another device 702. In other cases, a single device, such as device 702(5) may include a self-contained version of the TICC 710(5) that can perform the mapping functions and train the latent subspace and apply the mapping functions to new queries received by the search engine 816(5) of FIG. 8 and produce ranked search results for the new queries from the mapped functions.

For example, referring again to the example in FIG. 8, the client-side device 702(1) can send an uncorrelated textual query 822 to the server-side device 702(5). In this example, the relevance determination module 820 can use mapping functions (such as mapping functions 112 in FIG. 1) developed by the subspace mapping module 818 to map the uncorrelated textual query 822 in a click-through-based structured latent subspace (such as latent subspace 200 in FIG. 2). The relevance determination module 820 can determine a relevance ranking of visual images to the uncorrelated textual query, producing ranked search results 824 (similar to ranked image search list 206 in FIG. 2). The server-side device 702(5) can send the ranked search results 824 to the client-side device 702(1).

In summary, a text-image correlation component can learn a click-through-based structured latent subspace for correlation of textual queries and visual images. The latent subspace can be mapped based on click-through data and structures of original spaces of the textual queries and the visual images. The relevance of the textual queries and the visual images can then be used to rank visual image search results in response to the textual queries.

Note that the user's privacy can be protected while implementing the present concepts by only collecting user data upon the user giving his/her express consent. All privacy and security procedures can be implemented to safeguard the user. For instance, the user may provide an authorization (and/or define the conditions of the authorization) on his/her device or profile. Otherwise, user information is not gathered and functionalities can be offered to the user that do not utilize the user's personal information. Even when the user has given express consent the present implementations can offer advantages to the user while protecting the user's personal information, privacy, and security and limiting the scope of the use to the conditions of the authorization.

### Method Examples

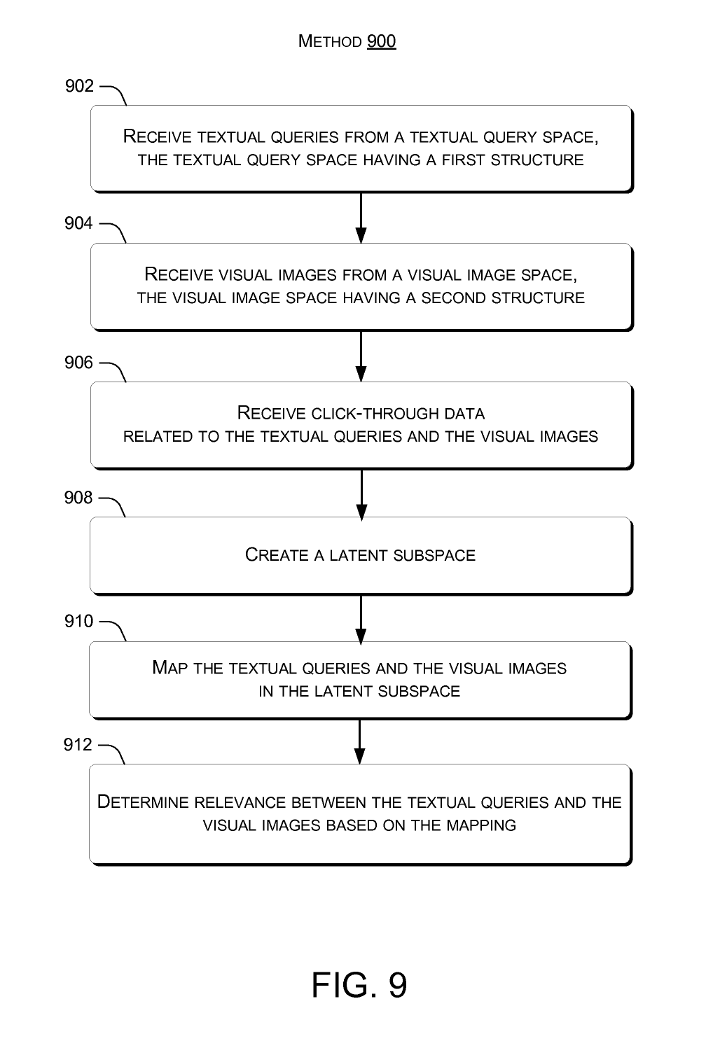

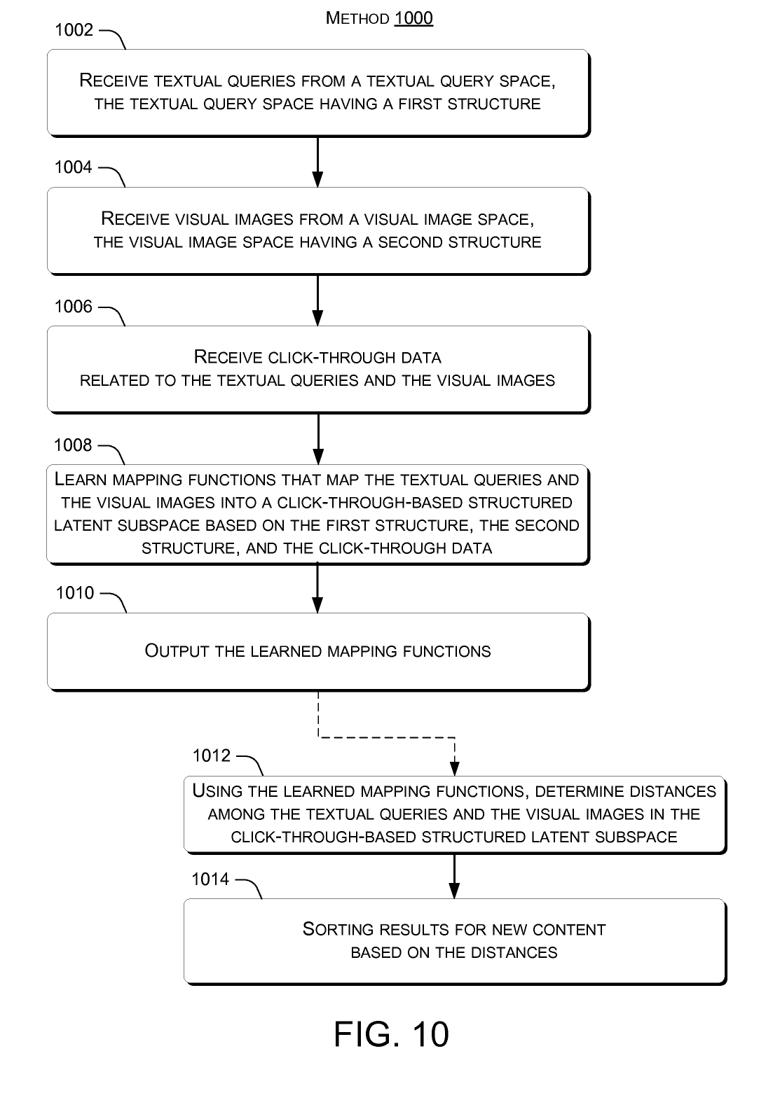

FIGS. 9-10 show example click-through-based cross-view learning methods 900 and 1000. Generally speaking, methods 900 and 1000 relate to determining relevance among and/or between content, such as textual queries and visual images through click-through-based cross-view learning techniques.

As shown in FIG. 9, at block 902, method 900 can receive textual queries from a textual query space. The textual query space can have a first structure. In some cases, the first structure can be representative of similarities between pairs of the textual queries in the textual query space.

At block 904, method 900 can receive visual images from a visual image space. The visual image space can have a second structure. In some cases, the second structure can be representative of similarities between pairs of the visual images in the visual image space.

At block 906, method 900 can receive click-through data related to the textual queries and the visual images. In some cases, the click-through data can include click numbers representing a number of times an individual visual image is clicked in response to an individual textual query.

At block 908, method 900 can create a latent subspace. In some implementations, the latent subspace can be a low-dimensional common subspace that can be used to represent the textual queries and the visual images.

Viewed from one perspective, the latent subspace can be defined as a new space shared by multiple views by assuming that the input views are generated from this latent subspace. The dimensionality of the latent subspace can be lower than that of any input view, so subspace learning is effective in reducing the “curse of dimensionality.” The construction of the latent subspace can be a core component of some of the inventive aspects and some of the inventive aspects can come from the exploration of cross-view distance and structure preservation, which have not been previously attempted.

At block 910, method 900 can map the textual queries and the visual images in the latent subspace. The mapping can include determining distances between textual queries and the visual images in the latent subspace. In some cases the distances can be based at least in part on the click numbers described relative to block 906. In some cases the mapping can also include preservation of the first structure from the textual query space and the second structure from the visual image space.

At block 912, method 900 can determine relevance between the textual queries and the visual images based on the mapping. In some cases, the relevance can be determined between a first textual query and a second textual query, a first visual image and a second visual image, and/or the first textual query and the first visual image. In some cases, the relevance between textual queries and visual images can be determined based on the mapped distances in the latent subspace.

FIG. 10 presents a second example of click-through-based cross-view learning techniques. Similar to method 900, method 1000 can also use click-through data and structures from original textual query and visual image spaces to map a latent subspace. For example, at block 1002, method 1000 can receive textual queries from a textual query space. The textual query space can have a first structure. At block 1004, method 1000 can receive visual images from a visual image space. The visual image space can have a second structure. At block 1006, method 1000 can receive click-through data related to the textual queries and the visual images.

At block 1008, method 1000 can learn mapping functions that map the textual queries and the visual images into a click-through-based structured latent subspace based on the first structure, the second structure, and the click-through data. At block 1010, method 1000 can output the learned mapping functions.

At block 1012, method 1000 can use the learned mapping functions (and/or other mapping functions) to determine distances among the textual queries and the visual images in the click-through-based structured latent subspace.

At block 1014, method 1000 can sort results for new content based on the distances. New content can include a new textual query, a new visual image, two or more new textual queries or visual images, or content from other modalities, such as audio or video. For example, a new textual query may be received that is not one of the textual queries used to learn the mapping functions in blocks 1002-1008. In this case, the method can use the mapping functions and/or the learned latent subspace to determine relevance of visual images to the new textual query, and sort the visual images into ranked search results. In other examples, the results can be textual queries, other modalities such as audio or video, or a mixture of modalities. For example, a ranked search result list could include visual images, video, and/or audio results for the new content.

Method 1000 may be performed by a single device or by multiple devices. In one case, a single device, such as a device performing a search engine functionality could perform blocks 1002-1014. In another case, a first device may perform some of the blocks, such as blocks 1002-1010 to produce the learned mapping functions. Another device, such as a device preforming the search engine functionality could leverage the learned mapping functions in performing blocks 1012-1014 to produce improved image results when users submit new search queries.

The described methods can be performed by the systems and/or devices described above, and/or by other devices and/or systems. The order in which the methods are described is not intended to be construed as a limitation, and any number of the described acts can be combined in any order to implement the method, or an alternate method. Furthermore, the method can be implemented in any suitable hardware, software, firmware, or combination thereof, such that a device can implement the method. In one case, the method is stored on computer-readable storage media as a set of instructions such that execution by a computing device causes the computing device to perform the method.

### CONCLUSION

The description relates to click-through-based cross-view learning. In one example, a click-through-based structured latent subspace can be used to directly compare textual queries and visual images. In some implementations, a click-through-based cross-view learning method can include determining distances between textual query and visual image mappings in the latent subspace. The distances between the textual queries and the visual images can be weighted by click numbers from click-through data. The click-through-based cross-view learning method can also include preserving structure relationships between textual queries and visual images in their respective original feature spaces. In some cases, after the mapping of the latent subspace, a relevance between textual queries and visual images can be measured by their mappings. In other cases, relevance between two textual queries and/or between two visual images can be measured by their mappings. The relevance scores can be used to rank images and/or queries in search results.

Although techniques, methods, devices, systems, etc., pertaining to providing accurate search results are described in language specific to structural features and/or methodological acts, it is to be understood that the subject matter defined in the appended claims is not necessarily limited to the specific features or acts described. Rather, the specific features and acts are disclosed as exemplary forms of implementing the claimed methods, devices, systems, etc.

1. A method implemented by one or more computing devices, the method comprising:
receiving textual queries from a textual query space, the textual query space having a first structure;
receiving visual images from a visual image space, the visual image space having a second structure;
receiving click-through data related to the textual queries and the visual images;
creating a latent subspace;
mapping the textual queries and the visual images in the latent subspace, wherein the mapping is based on:
the click-through data, and
preservation of the first structure from the textual query space and the second structure from the visual image space; and
determining relevance between the textual queries and the visual images based on the mapping.

2. The method of claim 1, the determining relevance further comprises determining relevance between a new textual query and new visual images based on the mapping.

3. The method of claim 1, wherein the first structure is representative of similarities between pairs of the textual queries in the textual query space and the second structure is representative of similarities between pairs of the visual images in the visual image space.

4. The method of claim 1, wherein the latent subspace is a low-dimensional common subspace that represents the textual queries and the visual images.

5. The method of claim 1, wherein the mapping comprises determining distances between the textual queries and the visual images in the latent subspace.

6. The method of claim 1, wherein the click-through data include click numbers representing a number of times individual visual images are clicked in response to individual textual queries.

7. The method of claim 6, wherein the mapping comprises determining distances between the textual queries and the visual images in the latent subspace based at least in part on the click numbers.

8. The method of claim 7, wherein a higher individual click number for a textual query-visual image pair corresponds to a smaller distance between the textual query-visual image pair in the latent subspace.

9. The method of claim 1, wherein the determining the relevance comprises determining relevance between:
a first textual query and a second textual query;
a first visual image and a second visual image; or
the first textual query and the first visual image.

10. The method of claim 1, the method further comprising ranking the visual images for a given individual textual query based on the relevance.

11. The method of claim 1, wherein the method is implemented by a single computing device.

12. A computer-readable memory device or storage device storing computer-readable instructions that, when executed by one or more processing devices, cause the one or more processing devices to perform acts comprising:
receiving textual queries from a textual query space, the textual query space having a first structure;
receiving visual images from a visual image space, the visual image space having a second structure;
receiving click-through data related to the textual queries and the visual images; and
learning mapping functions that map the textual queries and the visual images into a click-through-based structured latent subspace based on the first structure, the second structure, and the click-through data.

13. The computer-readable memory device or storage device of claim 12, wherein the click-through-based structured latent subspace is a low-dimensional common subspace that allows comparison of the textual queries and the visual images.

14. The computer-readable memory device or storage device of claim 12, the acts further comprising projecting the textual queries and the visual images into the click-through-based structured latent subspace and using the learned mapping functions to calculate distances between the textual queries and the visual images.

15. The computer-readable memory device or storage device of claim 14, the acts further comprising ranking the visual images based on the distances for an individual textual query.

16. A system, comprising:
storage configured to store computer-readable instructions comprising a text-image correlation component;
the text-image correlation component, comprising:
a subspace mapping module configured to use learned mapping functions to determine distances among textual queries and/or visual images in a click-through-based structured latent subspace, and
a relevance determination module configured to sort results for new content based on the distances in the click-through-based structured latent subspace; and
a processor configured to execute the computer-readable instructions associated with the text-image correlation component.

17. The system of claim 16, wherein the learned mapping functions for determining the distances of the textual queries and the visual images in the click-through-based structured latent subspace are based on:
click-through data for pairs of the textual queries and the visual images, and
structures of an original textual query space of the textual queries and an original visual image space of the visual images.

18. The system of claim 17, wherein the subspace mapping module is further configured to learn the learned mapping functions.

19. The system of claim 16, wherein the relevance determination module is further configured to determine relevance scores between an individual textual query and individual visual images based on the distances.

20. The system of claim 16, wherein the new content comprises a textual query that is not one of the textual queries, or wherein the new content comprises two or more new textual queries, or wherein the new content comprises a visual image that is not one of the visual images, or wherein the new content comprises two or more new visual images.

21. The system of claim 16, wherein the determining distances among textual queries and/or visual images comprises determining distances between individual textual queries, or comprises determining distances between individual visual images, or comprises determining distances between individual textual queries and individual visual images.

22. The system of claim 16, wherein the results comprise visual image results or textual query results.
